(19) United States
(12) Patent Application Publication
(10) Pub. No.: US 2025/0191337 A1
(43) Pub. Date: Jun. 12, 2025

(54) SYSTEM AND METHOD FOR FINUTING OF ZERO-SHOT VISION MODELS

(71) Applicant: Robert Bosch GmbH, Stuttgart (DE)

(72) Inventors: Devin T. WILLMOTT, Pittsburgh, PA (US); João D. SEMEDO, Pittsburgh, PA (US); Jeremy KOLTER, Pittsburgh, PA (US); Sachin GOYAL, Pittsburgh, PA (US); Anaya KUMAR, Stuttgart (DE); Sankalp GARG, Stuttgart (DE); Aditi RAGHUNATHAN, Stuttgart (DE)

(21) Appl. No.: 18/530,879

(22) Filed: Dec. 6, 2023

(51) Int. Cl. G06V 10/74; G06T 9/00

(52) U.S. Cl. CPC G06V 10/761; G06T 9/00

(57) ABSTRACT

A method discloses receiving a plurality of input images, receiving text prompts, generating a visual matrix utilizing the images and an image encoder, generating a text matrix utilizing a text encoder, multiplying the text matrix and the visual matrix to generate an image-text similarity matrix that assigns a numerical value indicating similarities between each of encoded visual descriptors and each of the encoded images, wherein similarities are indicated by entries of the image-text similarity matrix having numerical values that determine a loss function associated with the image-text similarity matrix, identify a gradient of the loss function with respect to parameters associated with the image encoder and parameters associated with the text encoder, utilizing the gradient, update parameters associated with the image encoder or the text encoder, and outputting final updated parameters associated with either the text encoder or image encoder of the machine learning network.

### TECHNICAL FIELD

The present disclosure relates to neural networks and machine learning, including those that utilize foundational models.

### BACKGROUND

Recent large-scale models pretrained jointly on image and text data, such as CLIP or ALIGN, may demonstrate exceptional performance on many zero-shot classification tasks. These models may be pretrained via a contrastive loss that finds a joint embedding over the paired image and text data. Then, for a new classification problem, one simply specifies a prompt (or, more commonly, a set of prompts) that describes the different classes. Finally, one can embed candidate images and predict the class with the highest similarity to the text embedding of the corresponding prompt. Such “zero-shot” classifiers involve no additional training at all and achieve reasonable performance on downstream tasks and impressive robustness to many common forms of distribution shift. However, in many cases, it is desirable to further improve performance via supervised fine-tuning: further training and updates to the pretrained parameters on a (possibly small) number of labeled images from the classification task.

In practice, however, several studies have found that standard finetuning procedures, while improving in-distribution performance, come at a cost to robustness to distribution shifts. Subtle changes to the fine-tuning process could mitigate this decrease in robustness. For example, prior systems have demonstrated the role of initialization of the final linear head and proposed a two-stage process of linear probing, then finetuning that achieves better than either method in isolation. As another example, other systems have showed that ensembling the weights of the finetuned and zero-shot classifier can improve robustness while simultaneously maintaining high in-distribution performance. Understanding the role of these subtle changes is challenging, and there is no simple recipe for what may be the “correct” modification. A common theme in all these previous methods is that they are small changes to the standard supervised training paradigm where the system may minimize a crossentropy loss on an image classifier. Indeed, such a choice is natural precisely because the system may be finetuning the system to improve classification performance. However, directly applying the supervised learning methodology for finetuning pretrained models without considering pretraining process can be suboptimal.

### SUMMARY

According to a first embodiment, a computer-implemented method for a pre-trained machine-learning network includes the steps of receiving a plurality of input images, receiving a plurality of text prompts associated with the plurality of input images, generating a visual matrix utilizing the plurality of input images and an image encoder of the machine learning network, wherein the image encoder is pre-trained and the visual matrix includes a list of encoded images, identify a contrastive loss associated with the plurality of text prompts prior to sending the plurality of text prompts to the model: generating a text matrix utilizing a text encoder of the machine learning network, wherein the text matrix includes a list of encoded text, multiplying the text matrix and the visual matrix to generate an image-text similarity matrix, wherein the image-text similarity matrix assigns a numerical value indicating similarities between each of encoded visual descriptors and each of the encoded images, wherein similarities are indicated by entries of the image-text similarity matrix having numerical values, utilizing the numerical values assigned at the image-text similarity matrix, determine a loss function associated with the image-text similarity matrix, identify a gradient of the loss function with respect to parameters associated with the image encoder and parameters associated with the text encoder, utilizing the gradient, update the parameters associated with the image encoder and the parameters associated with the text encoder, determining when a threshold is met; and in response to when a threshold is not met, repeating the above mentioned steps and when the threshold is met, outputting final updated parameters associated with the text encoder and image encoder of the machine learning network.

According to a second embodiment, a system includes a processor programmed to receive a plurality of input images, receive a plurality of text prompts associated with the plurality of input images, generate a visual matrix utilizing the plurality of input images and an image encoder of the machine learning network, wherein the image encoder is pre-trained and the visual matrix includes a list of encoded images, generate a text matrix utilizing a text encoder of the machine learning network, wherein the text matrix includes a list of encoded text, multiply the text matrix and the visual matrix to generate an image-text similarity matrix, wherein the image-text similarity matrix assigns a numerical value indicating similarities between each of encoded visual descriptors and each of the encoded images, wherein similarities are indicated by entries of the image-text similarity matrix having numerical values, utilizing the numerical values assigned at the image-text similarity matrix, determine a loss function associated with the image-text similarity matrix, identify a gradient of the loss function with respect to parameters associated with the image encoder and parameters associated with the text encoder, utilizing the gradient, update the parameters associated with the image encoder and the parameters associated with the text encoder, determine when a threshold is met, and in response to when a threshold is not met, repeating steps mentioned above and when the threshold is met, output final updated parameters associated with the text encoder and image encoder of the machine learning network.

According to a third embodiment, computer-implemented method discloses receiving a plurality of input images, receiving a plurality of text prompts associated with the plurality of input images, generating a visual matrix utilizing the plurality of input images and an image encoder of the machine learning network, wherein the image encoder is pre-trained and the visual matrix includes a list of encoded images, generating a text matrix utilizing a text encoder of the machine learning network, wherein the text matrix includes a list of encoded text, multiplying the text matrix and the visual matrix to generate an image-text similarity matrix, wherein the image-text similarity matrix assigns a numerical value indicating similarities between each of encoded visual descriptors and each of the encoded images, wherein similarities are indicated by entries of the image-text similarity matrix having numerical values, utilizing the numerical values assigned at the image-text similarity matrix, determine a loss function associated with the image-text similarity matrix, identify a gradient of the loss function with respect to parameters associated with the image encoder and parameters associated with the text encoder, utilizing the gradient, update the parameters associated with either the image encoder or the parameters associated with the text encoder, determining when a threshold is met, and in response to when a threshold is not met, repeating steps above and when the threshold is met, outputting final updated parameters associated with either the text encoder or image encoder of the machine learning network.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 illustrates a block diagram according to an embodiment of machine learning network utilizing a prompt searching.

FIG. 4 illustrates a flow chart of an embodiment utilizing prompt searching.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The present disclosure relates to fine-tuning of models, such as image-text models. Such models, such as CLIP, may achieve state-of-the-art accuracies on a variety of benchmarks. However, recent systems and methods have shown that even subtle differences in the fine-tuning process can lead to surprisingly large differences in the final performance, both for in-distribution (ID) and out-of-distribution (OOD) data. In this disclosure, an approach of mimicking contrastive pretraining consistently outperforms alternative fine-tuning approaches. Specifically, the system and method may cast downstream class labels as text prompts and continue optimizing the contrastive loss between image embeddings and class-descriptive prompt embeddings (e.g., contrastive fine-tuning).

Such a system and method may consistently outperforms baselines across 7 distribution shift, 6 transfer learning, and 3 few-shot learning benchmarks. For example, on WILDS, ImageNet, and five derived distribution shifts from ImageNet, contrastive fine-tuning improves accuracy by an average of 1.8% ID and 4.2% OOD compared to vanilla fine-tuning and an average of 1.1% ID and 1.3% OOD compared to state of the art. Similarly, on 3 few-shot learning benchmarks, such an approach gives gains up to 4.6% over vanilla fine-tuning and 4.4% over the state-of-the-art. Thus the proposed method of contrastive fine-tuning may be state-of-the-art for supervised finetuning of image-text models like CLIP.

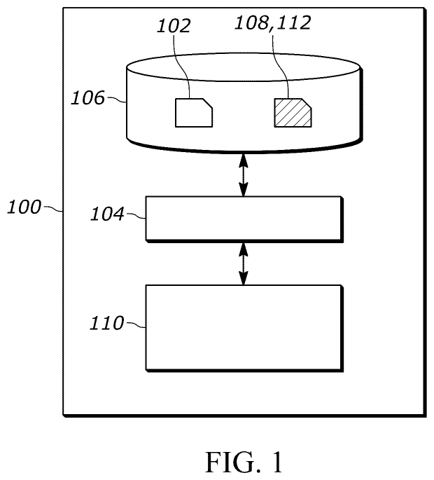

Reference is now made to the embodiments illustrated in the Figures, which can apply these teachings to a machine learning model or neural network. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

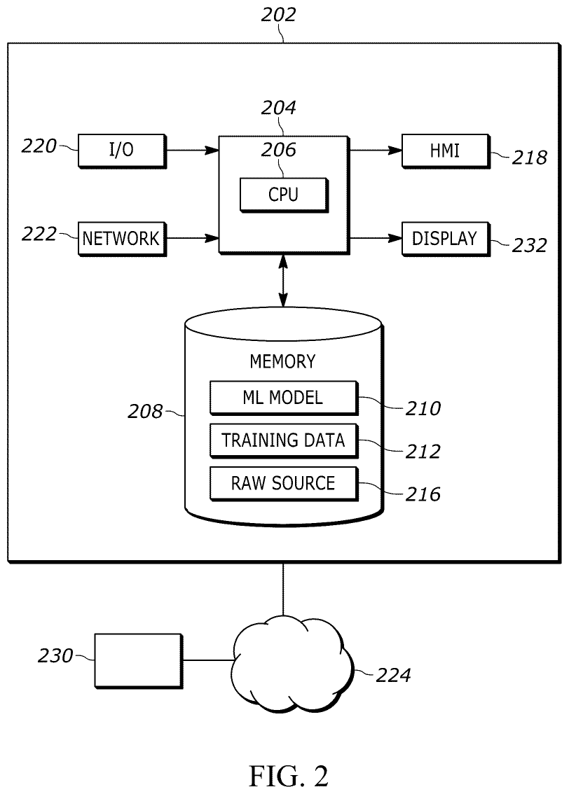

The structure of the system 100 is one example of a system that may be utilized to train a pre-trained machine learning network that utilizes few-shot image learning described herein. Additional structure for operating and training the machine-learning models is shown in FIG. 2.

FIG. 2 depicts a system to implement the machine-learning models described herein, for example the pre-trained machine learning network that utilizes few-shot image learning described herein. The system 200 can be implemented to perform few-shot image learning described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The processor may include a controller, tensor processing unit, graphics processing unit, ASIC, FPGA, etc. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines: timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface).

The computing system 202 may include a human-machine interface (HMI) device 218 that may include any device that enables the system to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

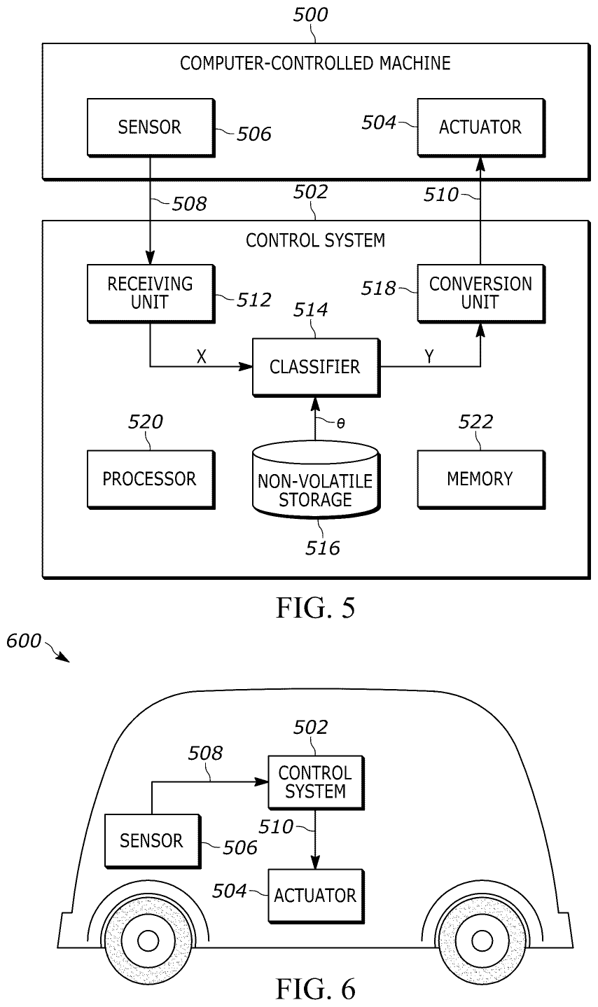

The system may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate the pre-trained machine learning network that utilizes zero-shot or few-shot image learning described herein.

The computer system may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). The input images may include various scenarios in which the objects are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a road sign in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., road sign). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In an example, the raw source data 216 may include image data representing an image. Applying the machine-learning algorithms (e.g., few-shot image learning, CLIP models, etc.) described herein, the output can be a tuned network associated with a set of images.

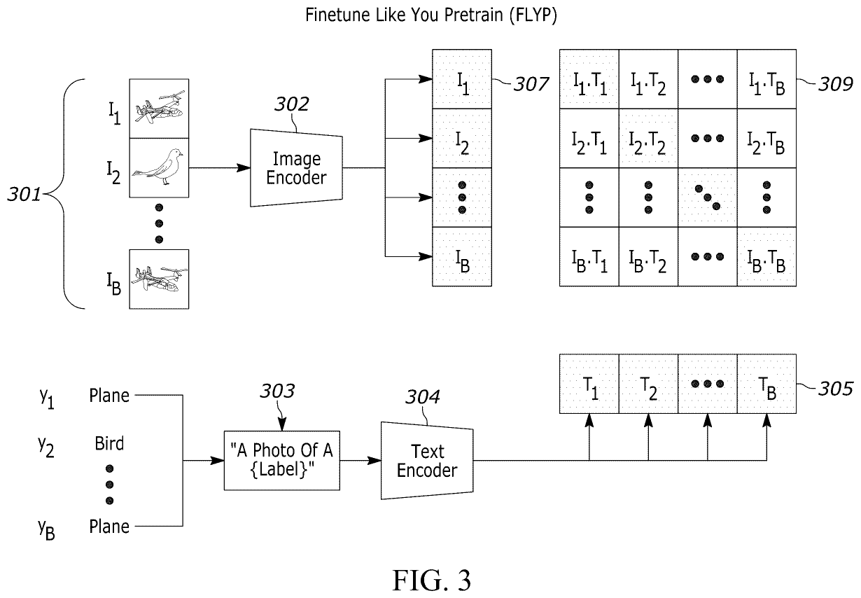

In this disclosure, a system and method may show an alternative, straightforward approach reliably outperforms prior art. Specifically, the embodiments disclosed may show that fine-tuning a classifier via a same or similar pretraining (contrastive) loss or similar pretraining (contrastive) loss leads to uniformly better performance of the resulting classifiers. That is, after constructing prompts from the class labels, the system may directly minimize the contrastive loss between these prompts and the image embeddings of our (labeled) fine-tuning set. Such an approach may be called, for example, finetune like you pretrain (FLYP) as summarized in FIG. 3. The FLYP process may result in better ID and OOD performance than alternative approaches without any additional features such as multi-stage finetuning or ensembling. When ensembling, it further boosts gains over ensembling with previous methods. This contrastive finetuning is done entirely “naively”: it ignores the fact that classes within a minibatch may overlap or that multiple prompts can correspond to the same class. Yet the fact that it works so well highlights an apparent benefit to finetuning models on the same loss which they were trained upon, a connection that has been observed in other settings as well.

Such an approach as described below consistently outperforms the existing state-of-the-art finetuning methods. Specifically, in “traditional” tasks such as ImageNet and applicable WILDS datasets, FLYP outperforms other methods in terms of both ID and OOD performance—averaged across the 7 out-of-distribution (OOD) datasets, FLYP gives gains of 1.8% ID and 4.2% OOD over full fine*tuning and 1.1% ID and 1.3% OOD over the current state-of-the-art, LP-FT. Such an advantage holds for few-shot fine*tuning, where only a very small number of examples of each class are present. For example, on binary few-shot classification, such a proposed approach FLYP outperforms the baselines by 4.4% on Rendered-SST2 and 3.8% on PatchCamelyon dataset. Arguably, these few-shot tasks represent the most likely use case for zero-shot fine*tuning, where one has both an initial prompt, a handful of examples of each class type, and wishes to build the best classifier possible. Finally, the system may illustrate through a number of ablation experiments that the contrastive loss itself seems key to this advantage: for example, simply updating both the image and text embedding networks via a joint cross-entropy loss performs worse than contrastive fine-tuning. Such a system and method outperforms existing (some being far more complex) fine-tuning methods that have been proposed. In total, these results point towards a simple and effective approach that would benefit as the “standard” method for fine-tuning zero-shot classifiers rather than tuning via a traditional supervised loss.

According to an embodiment of FIG. 3 the system may fine-tune a model in a certain way, which may be referenced to Finetune Like You Pretrain (FLYP). Given a downstream classification dataset, standard finetuning approaches may revolve around using the cross-entropy loss. In this embodiment, the system may show that simply using the same loss as the pretraining (e.g., contrastive loss, with “task supervision” coming from the text description of labels) may outperform state-of-the-art approaches known in the art, such as LP-FT and WiseFT. For example, on ImageNet, our proposed approach outperforms LP-FT+weight ensembling by 1.1% ID accuracy and 1.3% OOD accuracy, with a ID-OOD frontier curve (orange curve) dominating those of the baselines, i.e. lies above and to the right of all the baselines.

In one example, a system may consider an image classification setting where the goal is to map an image I∈ [symbol] to a label [symbol] ∈ [symbol] . The system may use image-text pretrained models, for example CLIP, that learn joint embeddings of image and text. Let f: [symbol] → [symbol] denote the image encoder that maps an image to a d-dimensional image-text embedding space. f may parameterized by parameters θ_{img}. Let T be the space for text descriptions of images. Analogously, g: [symbol] → [symbol] may be the language encoder with model parameters θₜₑₓₜ.

The system may utilized contrastive pretraining with language supervision in one embodiment. In such an example, the backbone of the pretraining objective may be contrastive learning, where the goal is to align the embedding g(Iᵢ) of an image close to the embedding g(Tᵢ) of its corresponding text description, and away from other text embeddings g(Tⱼ) in the batch. Given a batch with B images with their corresponding text descriptions D={(I₁,T₁), . . . (I_{B},T_{B})}, pretraining objective is as follows:

$${L}_{p r e} ( D , θ ) := {\sum }_{i = 1}^{B} - log \frac{exp ( \overline{f} ( {I}_{i} ) \times \overline{g} ( {T}_{i} ) )}{{\sum }_{j = 1}^{B} exp ( \overline{f ( {I}_{ι} ) \times \overline{g} ( {T}_{j} ) )}} + {\sum }_{i = 1}^{B} - log \frac{exp ( \overline{f} ( {I}_{i} ) \times \overline{g} ( {T}_{t} ) )}{{\sum }_{J = 1}^{B} exp ( \overline{f ( {I}_{j} ) \times \overline{g} ( {T}_{ι} ) )}}$$

where θ=[θ_{img},θₜₑₓₜ] are image and text encoder parameters, and f̅ and g̅ are the [symbol] ₂ normalized versions of f and g respectively. A CLIP model may use the same pretraining objective, which can be viewed as training on a proxy classification task consisting of 1 image and B classes from text embeddings (and symmetrically 1 text and B classes from image embeddings).

In another example, the system and method may include finetuning of pretrained models. The system and method may be given access to a few training samples {(x₁,y₂), . . . (xₙ,yₙ)}˜P_{id}, corresponding to the downstream image classification task of interest. Standard methods of leveraging pretrained image-text models like CLIP are as may include zero-shot (ZS) tuning, linear probing (LP), full finetuning (FFT), linear probing fullfinetuing (LP-FT), etc.

Since the pretrained image embeddings are trained to be aligned with the text embeddings, we can perform zero-shot classification without updating any weights. Given k classes (names) {c₁, c₂, . . . cₖ} we construct corresponding text descriptions {T₁, . . . Tₖ} (for e.g. “a photo of a c₁”). The zero-shot prediction corresponding to image I is

$$arg {max}_{1} {\overline{g} ( {T}_{i} )}^{T} \overline{f} ( I ) ,$$

where g̅ and f̅ are the normalized text and image embeddings. This can be written as arg maxᵢ(h_{zs}^{T}f̅(I))ᵢ where h_{zs} ∈ [symbol] is the zeroshot linear head with columns corresponding to text descriptions of the classes Tₖ.

In linear probing (LP), the system may learn a linear classifier h_{class} ∈ [symbol] on top of frozen image embeddings f̅ (I) by minimizing the cross-entropy on labeled data from the downstream distribution. In full finetuning, the system and method may update both a linear head h_{class} ∈ [symbol] and the parameters of the image encoder θ_{img} (initialized at the pretrained value) by minimizing the cross-entropy loss on labeled downstream data. Rather than initializing randomly, the system may use the zero-shot weights h_{zs} to initialize the linear head. The system may perform a two-stage finetuning process where the system may first perform linear probing and then full finetuning with h_{class} initialized at the linear-probing solution obtained in the first stage. With weight ensembling, the system and method may ensemble the weights by linearly interpolating between the weights of the zero-shot model and a finetuned model. Let θ_{img} denote the pretrained weights of the image encoder, and θ′_{img} denote the finetuned weights. Then weights of weight ensembled model are given as:

$${θ}_{w e} = a {θ}_{i m g}^{′} + ( 1 - a ) {θ}_{i m g} ,$$

FIG. 3 discloses a system over of a machine learning network according to an embodiment. The system and method according to an embodiment may utilize a pretrained model, like CLIP, to improve performance on a classification task given access to labeled data corresponding to the task. The system and method (described as FLYP) is essentially to continue pretraining, with “task supervision” coming from text descriptions of the corresponding target class names in the dataset. The algorithm may be a natural extension of pretraining. One or more images 301 may be received at an image encoder 302 of the machine learning network. The images 301 may be paired with one or more text labels 303. The text labels may be fed to a text encoder 304.

A visual matrix 307 may be generated by the image encoder 302. The visual matrix 307 may be include a list of encoded images. A text matrix 305 may be generated by the text encoder 304. The system may generate an image-text similarity matrix 309 that includes values indicating similarities between the encoded visual descriptors of the encoded images.

Given a label y, let T_{y} denote a set of possible text descriptions of the class. Let Pₜₑₓₜ (y) denote the uniform distribution over possible text descriptions. For example, these descriptions could include different contexts such as “a photo of a small {class}.” Given a batch of labeled samples D={(I₁, y₁), . . . (I_{B}, y_{B})}, the system may construct a corresponding batch D′ of image-text pairs and update the model parameters via stochastic gradient descent on the same pretraining objective (Equation 1), which is summarized below as Algorithm 1.

Inference using the fine-tuned encoders f′ and g′ is performed in the same way as zero-shot prediction, except using the finetuned encoders f′ and g′. For example, the prediction for an image I is again given by arg max₁g̅′(T₁)^{T}f̅′(I).

In one example, the embodiment disclosed may have a system and process that may update the language encoders. While standard fine-tuning methods may only update the image encoder, the system and method described above may continue pretraining that allows for updates on both the image and language encoders.

An example algorithm is described below:

Algorithm 1 FLYP: Contrastive Finetuning (One batch)

Given:
Pretrained parameters θ_{img} and θₜₑₓₜ,
Labeled batch D = {(x₁, y₁), ... (x_{B}, y_{B})},
Distribution on text description Pₜₑₓₜ(y), y ∈ [symbol]
Learning rate α

The training step may include 2 steps:
1. Create text/image paired data via labels

D′={(I₁,T₁), . . . (I_{B},T_{B})}, where Tᵢ˜Pₜₑₓₜ(yᵢ)
2. Update parameters via contrastive loss

$$θ := θ - a ∇ {ℒ}_{p r e} ( {D}^{′} , θ ) . \qquad ( Equation 1 )$$

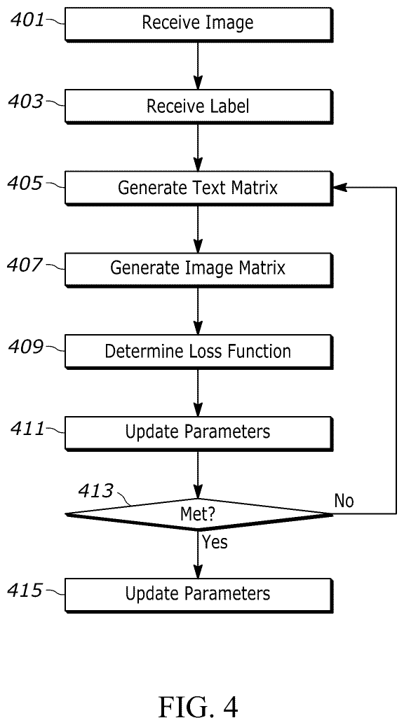

FIG. 4 illustrates a flow chart of a process according to an embodiment below. At step 401, the system may receive an image. The one or more images may be received at an image encoder of the machine learning network. As discussed above, the machine learning network may be pretrained. At step 403, the system may receive one or more labels or text. The text encoder associated with the machine learning network may receive the one or more labels. The labels (e.g., text) may be associated with the images. The images 301 may be paired with one or more text labels 303. The text labels may be fed to a text encoder 304.

At step 405, the system may generate a text matrix. The text matrix may be generated by the text encoder utilizing the text labels and associated parameters of the text encoder. The text matrix may include values associated with the text as determined by the encoder.

At step 407, the system may generate an image matrix or visual matrix. The visual matrix may be generated by the image encoder of the machine learning network. The visual matrix 307 may be include a list of encoded images. A text matrix 305 may be generated by the text encoder 304. The system may generate an image-text similarity matrix 309 that includes values indicating similarities between the encoded visual descriptors of the encoded images.

At step 409, the system may determine a loss function associated with the images and associated labels. Given a label y, let Ty denote a set of possible text descriptions of the class.

At step 411, the system may update parameters to machine learning network. The system may have Pₜₑₓₜ(y) denote the uniform distribution over possible text descriptions. For example, these descriptions could include different contexts such as “a photo of a small {class}.” Given a batch of labeled samples D={(I₁,y₁), . . . (I_{B},y_{B})}, the system may construct a corresponding batch D′ of image-text pairs and update the model parameters via stochastic gradient descent on the same pretraining objective (Equation 1), which is summarized below as Algorithm 1.

At decision 413, the system may determine if a threshold is met. The threshold may be related to a loss function, iterations, convergence threshold, etc. For example, if a threshold relates to a contrastive loss function, the system may repeat to update parameters based on the loss function value meeting or exceed a certain value. If the threshold is associated with a number of iterations to change the parameters, the system and method may evaluate certain parameters for a number of iterations until those iterations are met. The system may select the optimal parameters upon the thresholds being met. If the thresholds are not met, the system may continue to update the various parameters for the batch.

At step 415, the system may update the final parameters of the network. The parameters may be updated as a result of meeting a threshold, whether that threshold relates to number of iterations, a value associated with a loss, a convergence threshold, etc. In one example, the system may update parameters via constative loss. This may be performed utilizing Equation 1 θ:=θ−a∇ [symbol] ₚᵣₑ(D′,θ) (Equation 1). Once updated, the performance of the machine learning network should be met with improvements.

The system may also create text/image paired data via labels according to the following step:

D′={(I₁,T₁), . . . (I_{B},T_{B})}, where Tᵢ˜Pₜₑₓₜ(yᵢ)

The linear head in the system and method described according to an embodiment may incorporates structure from the text embeddings of corresponding labels (e.g., some classes are closer than others). Thus the system may be able to simulate this effect for other finetuning methods by initializing the linear head with the zero-shot weights that are constructed from prompts. This will improve performance over randomly initializing the linear head, and thus it may be used as improved initialization for all baselines including full fine-tuning. However, the baselines still do not match FLYP.

In summary, FLYP includes some intuitively favorable factors over standard finetuning, but via our ablations, these do not fully explain the success of FLYP. It appears that fine-tuning in a similar fashion, or same fashion, as done in pretraining may be an important aspect for FLYP's method.

FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. Image data may be retrieved from these sensors, such as video images, picture images, radar images, sound images, etc. The images may represent video or picture data that may include a plurality of pixels that form a scene. A pixel may be the smallest addressable element in a raster image, or the smallest addressable element in a dot matrix display device. In most digital display devices, pixels may be the smallest element that can be manipulated through software. Each pixel may be a sample of an original or synthetic image. In one embodiment, more samples typically provide more accurate representations of the original. The intensity of each pixel may be variable. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above with regard to the image encoder or text encoder) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. In the context of sign-recognition and processing as described herein, the sensor 506 is a camera mounted to or integrated into the vehicle 600. Alternatively or in addition to one or more specific sensors identified above, sensor 506 may include a software module configured to, upon execution, determine a state of actuator 504. One non-limiting example of a software module includes a weather information software module configured to determine a classification of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

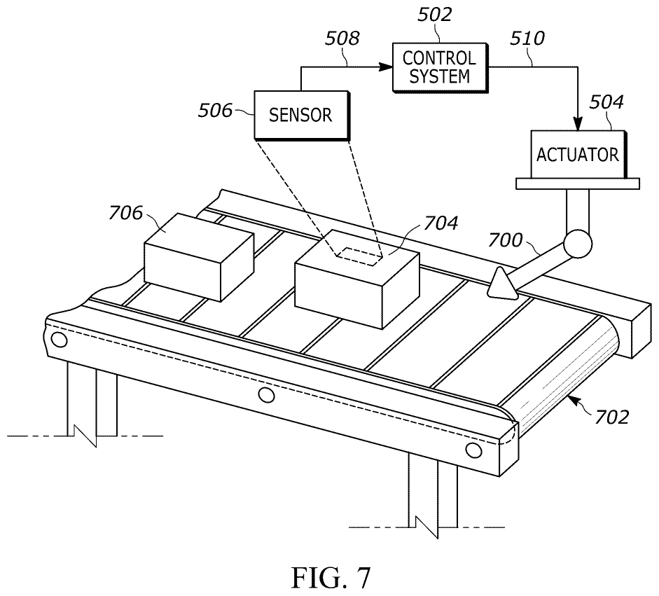

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 106 of system 700 (e.g., manufacturing machine) depending on the determined state of manufactured product 704.

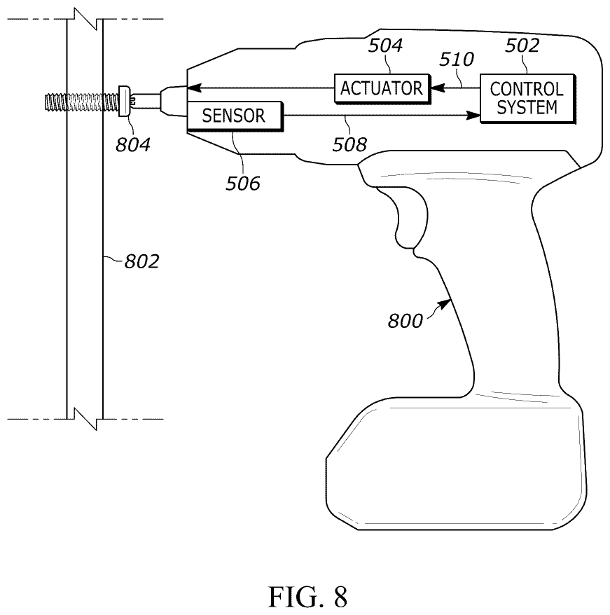

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

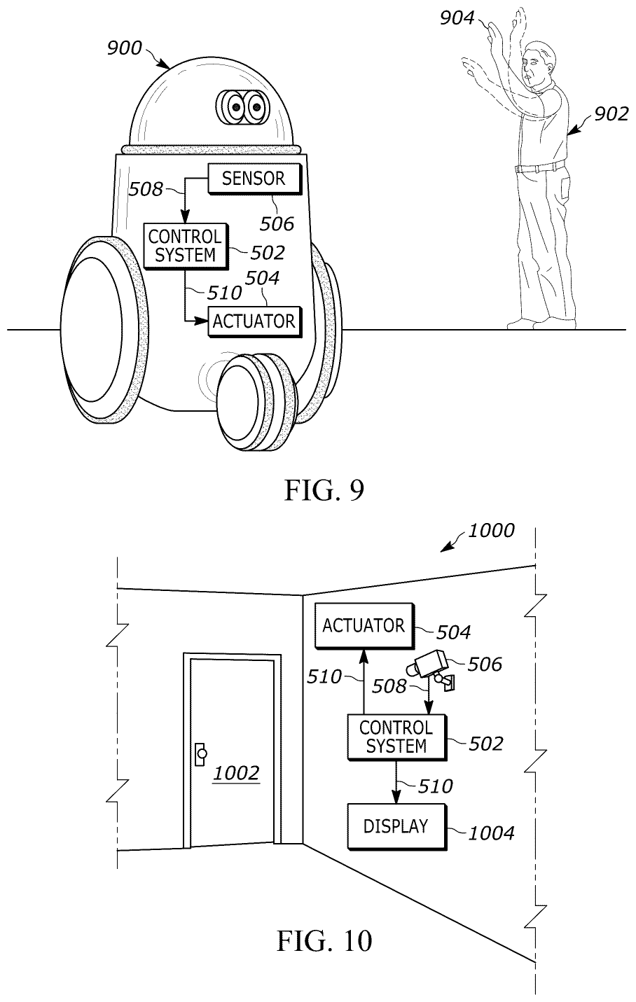

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object or classify it to a class obtained by classifier 514. Utilizing an embodiment of the system disclosed, the surveillance system may identify such objects.

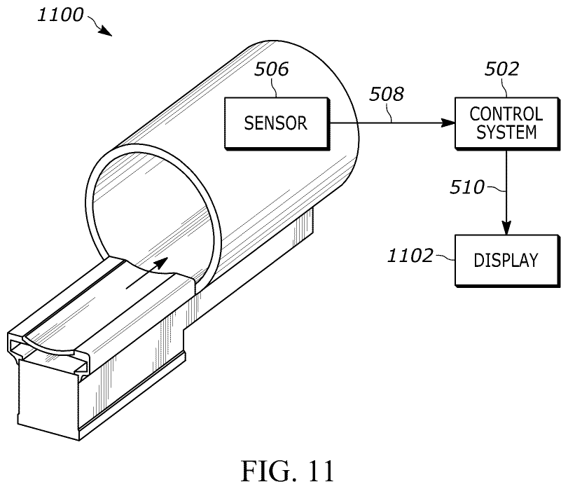

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to identify classification of a sensed image. In this case, actuator control command 510 may be determined or selected to cause display 1102 to display the imaging classify the MRI image, X-Ray image, or ultrasonic image.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for a pre-trained machine-learning network, the computer-implemented method comprising the following steps:
(i) receiving a plurality of input images;
(ii) receiving a plurality of text prompts associated with the plurality of input images
(iii) generating a visual matrix utilizing the plurality of input images and an image encoder of the machine learning network, wherein the image encoder is pre-trained and the visual matrix includes a list of encoded images;
(iv) generating a text matrix utilizing a text encoder of the machine learning network, wherein the text matrix includes a list of encoded text;
(v) multiplying the text matrix and the visual matrix to generate an image-text similarity matrix, wherein the image-text similarity matrix assigns a numerical value indicating similarities between each of encoded visual descriptors and each of the encoded images;
(vi) utilizing the numerical values assigned at the image-text similarity matrix, determining a loss function associated with the image-text similarity matrix;
(vii) identifying a gradient of the loss function with respect to parameters associated with the image encoder and parameters associated with the text encoder;
(viii) utilizing the gradient, updating the parameters associated with the image encoder and the parameters associated with the text encoder;
(ix) determining when a variable associated with the machine learning network meets a threshold; and
(x) in response to when the variable does not meet the threshold, repeating steps (iii-ix) and when the variable meets the threshold, outputting final updated parameters associated with the text encoder and image encoder of the machine learning network.

2. The method of claim 1, wherein the machine learning network is a vision-language model.

3. The method of claim 1, wherein the machine learning network is a CLIP model.

4. The method of claim 1, wherein the text encoder is a contrastive language-image pre-training (CLIP) text encoder and the image encoder is a CLIP image encoder.

5. The method of claim 1, wherein parameters associated with either only one of the image encoder or the text encoder are not modified.

6. The method of claim 1, wherein the variable is a number of iterations.

7. The method of claim 1, wherein the variable includes a batch size associated with a dataset including the images and plurality of text prompts.

8. The method of claim 1, wherein the variable is a convergence threshold.

9. The method of claim 1, wherein one of the text prompts is associated with a class representative of the one of the plurality of input images.

10. The method of claim 1, wherein the one or more models is a zero-shot model or a few-shot model.

11. The method of claim 1, wherein the loss function is computed utilizing the following formula:
$$ℒ := {\sum }_{i = 1}^{B} - log ( \frac{exp ( \overline{f} ( {I}_{i} ) \cdot \overline{g} ( {T}_{i} ) )}{{\sum }_{j = 1}^{B} exp ( \overline{f} ( {I}_{i} ) \cdot \overline{g} ( {T}_{j} ) )} ) + {\sum }_{i = 1}^{B} - log ( \frac{exp ( \overline{f} ( {I}_{i} ) \cdot \overline{g} ( {T}_{i} ) )}{{\sum }_{j = 1}^{B} exp ( \overline{f} ( {I}_{j} ) \cdot \overline{g} ( {T}_{i} ) )} )$$

12. The method of claim 1, wherein the image includes video, time series, radar, LIDAR, or audio.

13. The method of claim 1, wherein the loss function is a contrastive loss.

14. The method of claim 1, wherein the threshold is associated with the contrastive loss.

15. A system, comprising:
a processor programmed to:
(i) receive a plurality of input images;
(ii) receive a plurality of text prompts associated with the plurality of input images
(iii) generate a visual matrix utilizing the plurality of input images and an image encoder of the machine learning network, wherein the image encoder is pre-trained and the visual matrix includes a list of encoded images;
(iv) generate a text matrix utilizing a text encoder of the machine learning network, wherein the text matrix includes a list of encoded text;
(v) multiply the text matrix and the visual matrix to generate an image-text similarity matrix, wherein the image-text similarity matrix assigns a numerical value indicating similarities between each of encoded visual descriptors and each of the encoded images, wherein similarities are indicated by entries of the image-text similarity matrix having numerical values;
(vi) utilizing the numerical values assigned at the image-text similarity matrix, determine a loss function associated with the image-text similarity matrix;
(vii) identify a gradient of the loss function with respect to parameters associated with the image encoder and parameters associated with the text encoder;
(viii) utilizing the gradient, update the parameters associated with the image encoder and the parameters associated with the text encoder;
(ix) determine when a threshold is met; and
(x) in response to when a threshold is not met, repeating steps (iii-ix) and when the threshold is met, output final updated parameters associated with the text encoder and image encoder of the machine learning network.

16. The system of claim 15, wherein the threshold includes a contrastive loss threshold.

17. The system of claim 15, wherein the machine learning network is a contrastive language-image pretraining (CLIP) network.

18. The system of claim 15, wherein parameters associated with the image encoder and text encoder stay fixed.

19. The system of claim 15, wherein the threshold is associated with a convergence threshold.

20. A computer-implemented method, comprising:
(i) receiving a plurality of input images;
(ii) receiving a plurality of text prompts associated with the plurality of input images
(iii) generating a visual matrix utilizing the plurality of input images and an image encoder of the machine learning network, wherein the image encoder is pre-trained and the visual matrix includes a list of encoded images;
(iv) generating a text matrix utilizing a text encoder of the machine learning network, wherein the text matrix includes a list of encoded text;
(v) multiplying the text matrix and the visual matrix to generate an image-text similarity matrix, wherein the image-text similarity matrix assigns a numerical value indicating similarities between each of encoded visual descriptors and each of the encoded images, wherein similarities are indicated by entries of the image-text similarity matrix having numerical values;
(vi) utilizing the numerical values assigned at the image-text similarity matrix, determine a loss function associated with the image-text similarity matrix;
(vii) identify a gradient of the loss function with respect to parameters associated with the image encoder and parameters associated with the text encoder;
(viii) utilizing the gradient, update the parameters associated with either the image encoder or the parameters associated with the text encoder;
(ix) determining when a threshold is met; and
(x) in response to when a threshold is not met, repeating steps (iii-ix) and when the threshold is met, outputting final updated parameters associated with either the text encoder or image encoder of the machine learning network.
